(19) United States
(12) Patent Application Publication
(10) Pub. No.: US 2009/0017710 A1
(43) Pub. Date: Jan. 15, 2009

(54) Propylene Melt Blown Resins, Propylene Melt Blown Resin Fibers and Non-Woven Fabric Made From the Same, and Methods of Making the Same

(75) Inventors: Daniele Bugada, Newark, DE (US); Hee Ju Yoo, Wilmington, DE (US)

Correspondence Address: Basell USA Inc., Delaware Corporate Center II, 2 Righter Parkway, Suite #300, Wilmington, DE, 19803, US

(73) Assignee: Basell Polyolefine GmbH, Wesseling (DE)

(21) Appl. No.: 12/223,414

(22) PCT Filed: Feb. 2, 2007
(86) PCT No.: PCT/EP2007/051040

§ 371 Date: Jul. 30, 2008

Related U.S. Application Data
(60) Provisional application No. 60/765,463, filed on Feb. 2, 2006.

(51) Int. Cl. C08F 4/642; C08F 110/06; D04H 5/00

(52) U.S. Cl. 442/327; 526/351; 526/159

(57) ABSTRACT

A polypropylene homopolymer melt blown resin comprising a melt flow rate of about 300 to about 2500 g/10 min. at 230° C., a polydispersion index of about 1.3 to about 2.9, and a melting point of at least 160° C.

The present subject matter relates generally to propylene melt blown resins, and more particularly to propylene melt blown resins comprising a high melt flow rate and melting point. These propylene melt blown resins are capable of being processed more efficiently and cost effectively, and can be used to produce articles of manufacture having superior qualities. These compositions are further capable of being used to produce propylene melt blown resin fibers, which have superior mechanical and physical qualities.

Melt blown, non-woven fabrics are arguably the most demanding and technically advanced end-uses for melt blown resins. In particular, polypropylene homopolymer melt blown resins lead the way by offering a wide and diverse range of end-use products such as monolithic, heavy basis weight (thick) oil sorbents, baby wipes, and light weight, multi-layered and multi-material composite fabrics for personal hygiene, medical, and filtration applications.

One of the more valuable applications for melt blown resins is in producing fine melt blown resin fibers for non-woven fabrics, which are used as a barriers or filters. Typically, the finer the melt blown resin fibers, the smaller the pores in the non-woven fabric, which in turn leads to a more efficient barrier or filter apparatus. It is therefore not surprising that resin producers are constantly trying to improve melt blown resins by trying to decrease the viscosity of the resins, thereby increasing the melt flow rate, in order to achieve finer and finer fiber production. In addition to finer fiber production, by decreasing the viscosity of melt blown resins, more favorable and economic processing conditions can be achieved.

Originally, melt blown fabric converters purchased standard polypropylene resins and added organic peroxides during an extrusion conversion step to chemically degrade the polypropylene, raise the melt flow rate, and narrow the molecular weight distribution (i.e., polydispersion index) of the resins. This process is known as chemical vis-breaking. This process worked in principle, but lacked quality control and consistency, which is reflected in mediocre quality end products, and limited end-use applications.

In order to overcome these deficiencies, polypropylene producers introduced peroxide coated polypropylene for melt blown processes. To a large extent, these resins have permitted a higher achievable melt flow rate and melting temperature, and improved the quality of end products produced from the resins. In particular, melt blown non-woven fabrics were improved. Additionally, the peroxide coated polypropylene increased the capability of using finer fibers for end products, such as non-woven fabric products. However, variations in extruder processing conditions during resin conversion still result in inconsistencies in non-woven fabrics produced from peroxide coated polypropylene. Moreover, the process of chemical visbreaking inevitably generates decomposition by-products within the resin, which are transferred to the end product. Of course, these by-products limit the use of the end product, which also limit the use of peroxide coated polypropylene in melt blown processes generally.

In addition to decomposition by-products in the end products produced from peroxide treated or peroxide coated polypropylene melt blown resins, previous melt blown resins produced spinning smoke when the resins were processed into fibers. Spinning smoke arises from vaporization of low melting point fractions, volatiles, and other unwanted by-products within the melt blown resin. The more spinning smoke produced by a melt blown resin, the higher the emissions are for a plant producing fibers from the melt blown resin.

Moreover, besides higher emissions, spinning smoke can corrode processing dies used to manufacture the melt blown resin fibers. The corrosive nature of spinning smoke leads to lower die life, which in turn leads to higher production costs. Moreover, given the corrosive nature of spinning smoke, adequate safety precautions need to be taken when processing previously known melt blown resins, including peroxide treated or peroxide coated melt blown resins.

Accordingly, polypropylene melt blown resins comprising a high melt flow rate and melting point without being chemically vis-broken were previously unknown in the art. Additionally, many of the previously known melt blown resins were not capable of providing a resin with a high melt flow rate and smaller molecular weight distribution (i.e., lower polydispersion index), as well as a high melting point and a reduced amount of decomposition by-products.

Since the present melt blown resins have a higher melt flow rate, high melting point, lower polydispersion index, and reduced decomposition by-products, the throughput and productivity of processing plants producing melt blown resin fibers from the present resins can be increased. Additionally, the present melt blown resins produce finer melt blown resin fibers, which produce softer, more comfortable end products, with increased filtration properties. The increased filtration properties are due to finer fibers being produced, as well as an unexpected increase of static charge retention properties of the fibers.

Moreover, the present melt blown resins can be used to produce non-woven fabrics having improved fabric properties, such as hydrohead and air permeability. Even more so, the present melt blown resins can be used to produce products with enhanced homogeneity and consistency, thereby reducing the amount of scrap produced which increases raw material economics. The present melt blown resins can also be used to produce non-woven fabrics with smaller pore sizes than comparable non-woven fabrics produced from previously known melt blend resins.

In addition to increasing raw material economics, the present melt blown resins provide energy and resource savings due to lower processing temperatures and less process draw air needed to process the resins into fibers and non-woven fabric. Additionally, the present melt blown resins have less by-products and volatiles, which lead to less spinning smoke and plant emissions, and prolonged time between die cleanings and replacements when the resins are processed.

For these reasons, there remains a need in the art for melt blown resins of the present subject matter having a high melt flow rate and melting point, and lower polydispersion index.

The present subject matter relates generally to propylene melt blown resins, and more particularly to propylene melt blown resins comprising a high melt flow rate and melting point.

In this regard, a preferred embodiment of the present subject matter relates to a polypropylene homopolymer melt blown resin comprising a melt flow rate of about 300 to about 2500 g/10 min. at 23° C., a polydispersion index of about 1.3 to about 2.9, and a melting point of at least 160° C.

Another preferred embodiment of the present subject matter relates to a polypropylene homopolymer melt blown resin fiber comprising a propylene homopolymer melt blown resin comprising a melt flow rate of about 300 to about 2500 g/10 min. at 230° C., a polydispersion index of about 1.3 to about 2.9, and a melting point of at least 160° C.

Moreover, another preferred embodiment of the present subject matter relates to a non-woven fabric comprising a polypropylene homopolymer melt blown resin fiber comprising a propylene homopolymer melt blown resin comprising a melt flow rate of about 300 to about 2500 g/10 min. at 230° C., a polydispersion index of about 1.3 to about 2.9, and a melting point of at least 160° C.

Additionally, another preferred embodiment of the present subject matter relates to a multi-layered non-woven fabric comprising a polypropylene homopolymer melt blown resin fiber comprising a propylene homopolymer melt blown resin comprising a melt flow rate of about 300 to about 2500 g/10 min. at 230° C., a polydispersion index of about 1.3 to about 2.9, and a melting point of at least 160° C.

Yet another preferred embodiment of the present subject matter relates to a process for preparing a polypropylene homopolymer melt blown resin comprising contacting:
a metallocene compound of formula (I)

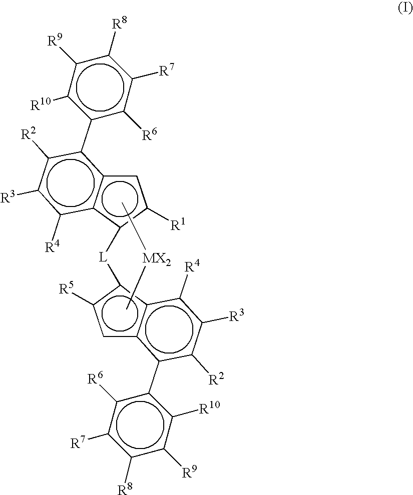

wherein

M is a transition metal of group 3, 4, 5, or 6, or is a lanthanide or actinide in the Periodic Table of Elements;

X is hydrogen, a halogen, or R, OR, OSO₂CF₃, OCOR, SR, NR₂, PR₂, and combinations thereof, or X can form a substituted or unsubstituted butadienyl radical or OR′O;

R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl, or C₇-C₄₀-arylalkyl radical and combinations thereof optionally containing heteroatoms belonging to groups 13-17 of the Periodic Table of Elements;

R′ is a divalent radical selected from C₁-C₄₀ alkylidene, C₆-C₄₀ arylidene, C₇-C₄₀ alkylarylidene, or C₇-C₄₀ arylalkylidene radical;

L is a divalent C₁-C₄₀ hydrocarbon radical optionally containing heteroatoms belonging to groups 13-17 of the Periodic Table of Elements or a divalent silylidene radical containing up to 5 silicon atoms;

R¹ and R⁵ are a C₁-C₄₀ hydrocarbon radical optionally containing heteroatoms belonging to groups 13-17 of the Periodic Table of Elements, wherein R¹ and R⁵ can be the same or different;

R², R³, and R⁴ are hydrogen or C₁-C₄₀ hydrocarbon radicals optionally containing heteroatoms belonging to groups 13-17 of the Periodic Table of Elements, wherein R², R³, and R⁴ can be the same or different;

R⁶, R⁷, R⁸, R⁹, and R¹⁰ are hydrogen or C₁-C₄₀ hydrocarbon radicals optionally containing heteroatoms belonging to groups 13-17 of the Periodic Table of Elements, wherein R⁶, R⁷, R⁸, R⁹ and R¹⁰ can be the same or different with the proviso that at least one of the group consisting of R⁶, R⁷, R⁸, R⁹, and R¹⁰ is not hydrogen;

at least one alumoxane or a compound able to form an alkylmetallocene cation;

optionally an organo aluminium compound; and

propylene monomer,

wherein said propylene monomer is polymerized to form the polypropylene homopolymer melt blown resin comprising a melt flow rate of about 300 to about 2500 g/10 min. at 230° C., a polydispersion index of about 1.3 to about 2.9, and a melting point of at least 160° C.

Moreover, another preferred embodiment of the present subject matter relates to a process for preparing a polypropylene homopolymer melt blown resin fiber comprising contacting:
a metallocene compound of formula (I)

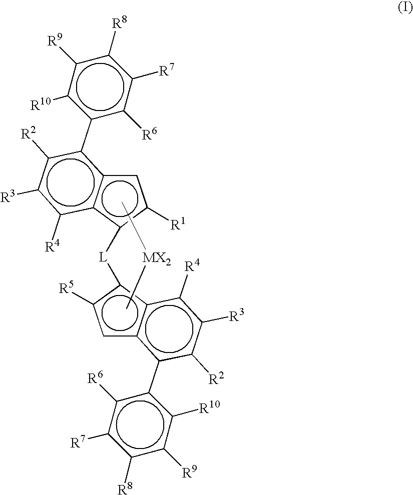

wherein

M is a transition metal of group 3, 4, 5, or 6, or is a lanthanide or actinide in the Periodic Table of Elements;

X is hydrogen, a halogen, or R, OR, OSO₂CF₃, OCOR, SR, NR₂, PR₂, and combinations thereof, or X can form a substituted or unsubstituted butadienyl radical or OR′O;

R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl, or C₇-C₄₀-arylalkyl radical and combinations thereof optionally containing heteroatoms belonging to groups 13-17 of the Periodic Table of Elements;

R′ is a divalent radical selected from C₁-C₄₀ alkylidene, C₆-C₄₀ arylidene, C₇-C₄₀ alkylarylidene, or C₇-C₄₀ arylalkylidene radical;

L is a divalent C₁-C₄₀ hydrocarbon radical optionally containing heteroatoms belonging to groups 13-17 of the Periodic Table of Elements or a divalent silylidene radical containing up to 5 silicon atoms;

R¹ and R⁵ are a C₁-C₄₀ hydrocarbon radical optionally containing heteroatoms belonging to groups 13-17 of the Periodic Table of Elements, wherein R¹ and R⁵ can be the same or different;

R², R³, and R⁴ are hydrogen or C₁-C₄₀ hydrocarbon radicals optionally containing heteroatoms belonging to groups 13-17 of the Periodic Table of Elements, wherein R², R³, and R⁴ can be the same or different;

R⁶, R⁷, R⁸, R⁹, and R¹⁰ are hydrogen or C₁-C₄₀ hydrocarbon radicals optionally containing heteroatoms belonging to groups 13-17 of the Periodic Table of Elements, wherein R⁶, R⁷, R⁸, R⁹ and R¹⁰ can be the same or different with the proviso that at least one of the group consisting of R⁶, R⁷, R⁸, R⁹, and R¹⁰ is not hydrogen;

at least one alumoxane or a compound able to form an alkylmetallocene cation;

optionally an organo aluminium compound; and

propylene monomer,

wherein said propylene monomer is polymerized to form a polypropylene homopolymer melt blown resin comprising a melt flow rate of about 300 to about 2500 g/10 min. at 230° C., a polydispersion index of about 1.3 to about 2.9 (measurement values?), and a melting point of at least 160° C.; said polypropylene homopolymer melt blown resin is processed in an extruder to form said polypropylene homopolymer melt blown resin fiber.

### BRIEF DESCRIPTION OF THE FIGURES

FIG. 1: Hydrostatic Pressure of 20 gsm Melt Blown Fabrics Produced at 0.6 ghm.

FIG. 2: Hydrostatic Pressure of 20 gsm Melt Blown Fabrics Produced at 0.8 ghm.

FIG. 3: Air Permeability of 20 gsm Melt Blown Fabrics Produced at 0.6 ghm.

FIG. 4: Air Permeability of 20 gsm Melt Blown Fabrics Produced at 0.8 ghm.

FIG. 5: Processing differences between 1100 g/10 min. MFR znPP and 1200 g/10 min. MFR metallocene PP.

### DEFINITIONS

As used herein, the term “melting point” refers to the final melting point of the resin, wherein a majority of the resin is melted and wherein the final melting point is different than the peak melting point and on set melting point.

As used herein, the term “peak melting point” refers to a temperature at which a majority of the resin is melting.

As used herein, the term “on set melting point” refers to a temperature at which the resin begins to melt.

As used herein, the term “fineness” refers to the thickness or diameter of the fibers produced.

### Catalyst Systems

There are a variety of catalyst systems available for producing general melt blown resins. Ziegler-Natta catalyst systems have been, and still are, used to produce general melt blown resins. However, the melt blown resins produced from Ziegler-Natta catalyst systems exhibit inferior mechanical and physical properties. In particular, known Ziegler-Natta catalyst systems are not able to produce melt blown resins having a higher melt flow rate and melting point, such as the melt blown resins of the present subject matter. In addition to having a lower melt flow rate and melting point than the present melt blown resins, the melt blown resins produced from Ziegler-Natta catalyst systems have a higher polydispersion index (i.e. molecular weight distribution), and have a greater amount of volatiles present within the resins, which results in a higher amount of spinning smoke when the resins are processed. As discussed above, a higher incident of spinning smoke when processing melt blown resins leads to higher emissions, and reduced time between die cleanings and die replacements.

Accordingly, the melt blown resins of the present subject matter alleviate these problems. In a preferred aspect, the present melt blown resins can be prepared by a metallocene catalyst system. Additionally, in a preferred aspect, the metallocene catalyst system comprises a metallocene compound of formula (I)

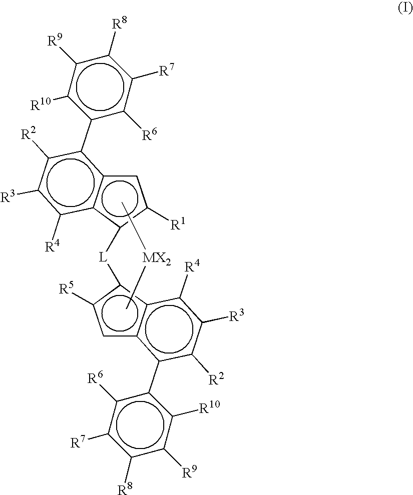

wherein

M is a transition metal of group 3, 4, 5, or 6, or is a lanthanide or actinide in the Periodic Table of Elements;

X is hydrogen, a halogen, or R, OR, OSO₂CF₃, OCOR, SR, NR₂, PR₂, and combinations thereof, or X can form a substituted or unsubstituted butadienyl radical or OR′O;

R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl, or C₇-C₄₀-arylalkyl radical and combinations thereof optionally containing heteroatoms belonging to groups 13-17 of the Periodic Table of Elements;

R′ is a divalent radical selected from C₁-C₄₀ alkylidene, C₆-C₄₀ arylidene, C₇-C₄₀ alkylarylidene, or C₇-C₄₀ arylalkylidene radical;

L is a divalent C₁-C₄₀ hydrocarbon radical optionally containing heteroatoms belonging to groups 13-17 of the Periodic Table of Elements or a divalent silylidene radical containing up to 5 silicon atoms;

R¹ and R⁵ are a C₁-C₄₀ hydrocarbon radical optionally containing heteroatoms belonging to groups 13-17 of the Periodic Table of Elements, wherein R¹ and R⁵ can be the same or different;

R², R³, and R⁴ are hydrogen or C₁-C₄₀ hydrocarbon radicals optionally containing heteroatoms belonging to groups 13-17 of the Periodic Table of Elements, wherein R², R³, and R⁴ can be the same or different;

R⁶, R⁷, R⁸, R⁹, and R¹⁰ are hydrogen or C₁-C₄₀ hydrocarbon radicals optionally containing heteroatoms belonging to groups 13-17 of the Periodic Table of Elements, wherein R⁶, R⁷, R⁸, R⁹ and R¹⁰ can be the same or different with the proviso that at least one of the group consisting of R⁶, R⁷, R⁸, R⁹, and R¹⁰ is not hydrogen, at least one alumoxane or a compound able to form an alkylmetallocene cation, and optionally an organo aluminum compound.

In a preferred aspect of the present subject matter, the metallocene catalyst system is prepared by contacting the metallocene compound of formula (I)

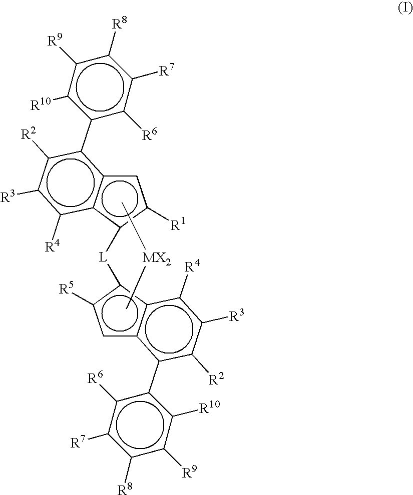

wherein

M is a transition metal of group 3, 4, 5, or 6, or is a lanthanide or actinide in the Periodic Table of Elements;

X is hydrogen, a halogen, or R, OR, OSO₂CF₃, OCOR, SR, NR₂, PR₂, and combinations thereof, or X can form a substituted or unsubstituted butadienyl radical or OR′O;

R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl, or C₇-C₄₀-arylalkyl radical and combinations thereof optionally containing heteroatoms belonging to groups 13-17 of the Periodic Table of Elements;

R′ is a divalent radical selected from C₁-C₄₀ alkylidene, C₆-C₄₀ arylidene, C₇-C₄₀ alkylarylidene, or C₇-C₄₀ arylalkylidene radical;

L is a divalent C₁-C₄₀ hydrocarbon radical optionally containing heteroatoms belonging to groups 13-17 of the Periodic Table of Elements or a divalent silylidene radical containing up to 5 silicon atoms;

R¹ and R⁵ are a C₁-C₄₀ hydrocarbon radical optionally containing heteroatoms belonging to groups 13-17 of the Periodic Table of Elements, wherein R¹ and R⁵ can be the same or different;

R², R³, and R⁴ are hydrogen or C₁-C₄₀ hydrocarbon radicals optionally containing heteroatoms belonging to groups 13-17 of the Periodic Table of Elements, wherein R², R³, and R⁴ can be the same or different;

R⁶, R⁷, R⁸, R⁹, and R¹⁰ are hydrogen or C₁-C₄₀ hydrocarbon radicals optionally containing heteroatoms belonging to groups 13-17 of the Periodic Table of Elements, wherein R⁶, R⁷, R⁸, R⁹ and R¹⁰ can be the same or different with the proviso that at least one of the group consisting of R⁶, R⁷, R⁸, R⁹, and R¹⁰ is not hydrogen, with at least one alumoxane or a compound able to form an alkylmetallocene cation, and optionally with an organo aluminum compound.

In another preferred aspect of the present subject matter, the metallocene catalyst system will comprise titanium, zirconium, or hafnium as M in the metallocene compound of formula (I). In another preferred aspect of the present subject matter, R is a linear or branched C₁-C₂₀-alkyl radical. In yet another preferred aspect of the present subject matter, X is hydrogen, a halogen, or R. In yet another preferred aspect of the present subject matter, X is chlorine or a C₁-C₁₀-alkyl radical. In yet another preferred aspect of the present subject matter, X is methyl, ethyl, and combinations thereof.

Moreover, in preferred aspect of the present subject matter, L is a divalent bridging group selected from a silyliene radical containing up to 5 silicon atoms, a C₁-C₄₀ alkylidene, a C₃-C₄₀ cycloalkylidene, a C₆-C₄₀ arylidene, a C₇-C₄₀ alkylarylidene, or a C₇-C₄₀ arylalkylidene radical optionally containing heteroatoms belonging to groups 13-17 of the Periodic Table of Elements in the metallocene compound of formula (I). In yet another preferred aspect of the present subject matter, L is SiMe₂ or SiPh₂. In yet another preferred aspect of the present subject matter, L is (Z(R″)₂)ₙ, wherein Z is carbon or silicon, n is 1 or 2, and R″ is a C₁-C₂₀ hydrocarbon radical optionally containing heteroatoms belonging to groups 13-17 of the Periodic Table of Elements. In yet another preferred aspect of the present subject matter, R″ is a linear or branched, cyclic or acyclic, C₁-C₂₀-alkyl, C₂-C₂₀ alkenyl, C₂-C₂₀ alkynyl, C₆-C₂₀-aryl, C₇-C₂₀-alkylaryl or C₇-C₂₀-arylalkyl radical, and combinations thereof, optionally containing heteroatoms belonging to groups 13-17 of the Periodic Table of the Elements.

Even more so, in a preferred aspect of the present subject matter, L is Si(CH₃)₂, SiPh₂, SiPhMe, SiMe(SiMe₃), CH₂, (CH₂)₂, or C(CH₃)₂ in the metallocene compound of formula (I). In yet another preferred aspect of the present subject matter, R¹ and R⁵ are a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radicals, optionally containing heteroatoms belonging to groups 13-17 of the Periodic Table of Elements, wherein R¹ and R⁵ can be the same or different. In yet another preferred aspect of the present subject matter, R¹ and R⁵ are a linear or branched, saturated or unsaturated C₁-C₂₀-alkyl radical.

Additionally, in a preferred aspect of the present subject matter, R², R³ and R⁴ are hydrogen, or a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radical, optionally containing heteroatoms belonging to groups 13-17 of the Periodic Table of Elements, wherein R², R³ and R⁴ can be the same or different in the metallocene compound of formula (I). In yet another preferred aspect of the present subject matter, R², R³ and R⁴ are hydrogen or a C₁-C₄₀-alkyl radical. In yet another preferred aspect of the present subject matter, R⁸ is a C₁-C₄₀-alkyl radical. In yet another preferred aspect of the present subject matter, R⁸ is a C₁-C₄₀-alkyl radical comprising a secondary carbon or a tertiary carbon in an alpha position to form an isopropyl or tertbutyl radical.

In a particular preferred aspect of the present subject matter, L is (Si)Me₂, M is Zr, X is Cl, R¹ is t-propyl, R², R³, and R⁴ are hydrogen, R⁵ is methyl, R⁶, R⁷, R⁹, and R¹⁰ are hydrogen, and R⁸ is t-butyl in the metallocene compound of formula (I).

In addition to the metallocene compound of formula (I), alumoxanes can be used in the catalyst system according to the present subject matter. The alumoxanes can be obtained by reacting water with an organo-aluminum compound of formula (II) or (III)

HⱼAlU₃₋ⱼ (II)

HⱼAl₂U₆₋ⱼ (III)

wherein U is hydrogen, a halogen, a C₁-C₂₀-alkyl, a C₃-C₂₀-cycloalkyl, a C₆-C₂₀-aryl, a C₇-C₂₀-alkylaryl or a C₇-C₂₀-arylalkyl radical, optionally containing silicon or germanium atoms, wherein U can be the same or different with the proviso that at least one U is not a halogen, and j ranges from 0 to 1, wherein j can also be a non-integer number. In this reaction a molar ratio of Al/water is preferably between 1:1 and 100:1.

The alumoxanes which can be used in the catalyst system according to the present subject matter are considered to be linear, branched, or cyclic compounds containing at least one group of formula (IV)

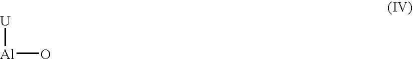

wherein U is defined above.

In particular, alumoxanes of formula (V)

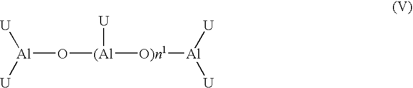

can be used in the case of linear compounds, wherein n¹ is 0 or an integer of from 1 to 40, and U is define above,

Additionally, alumoxanes of formula (VI)

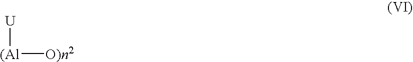

can be used, wherein n² is an integer from 2 to 40, and U is defined above.

Non-limiting examples of preferred alumoxanes suitable for use according to the present subject matter are methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO), and tetra-(2,3,3-trimethylbutyl)alumoxane (TTMBAO).

Particularly interesting cocatalysts are described in WO 99/21899 and in WO01/21674 in which the alkyl and aryl groups have specific branched patterns.

Non-limiting examples of aluminum compounds which can be reacted with water to give suitable alumoxanes are described in WO 99/21899 and WO01/21674, and include: tris(2,3,3-trimethyl-butyl)aluminum, tris(2,3-dimethyl-hexyl)aluminum, tris(2,3-dimethyl-butyl)aluminum, tris(2,3-dimethyl-pentyl)aluminum, tris(2,3-dimethyl-heptyl)aluminum, tris(2-methyl-3-ethyl-pentyl)aluminum, tris(2-methyl-3-ethyl-hexyl)aluminum, tris(2-methyl-3-ethyl-heptyl)aluminum, tris(2-methyl-3-propyl-hexyl)aluminum, tris(2-ethyl-3-methyl-butyl)aluminum, tris(2-ethyl-3-methyl-pentyl)aluminum, tris(2,3-diethyl-pentyl)aluminum, tris(2-propyl-3-methyl-butyl)aluminum, tris(2-isopropyl-3-methyl-butyl)aluminum, tris(2-isobutyl-3-methyl-pentyl)aluminum, tris(2,3,3-trimethyl-pentyl)aluminum, tris(2,3,3-trimethyl-hexyl)aluminum, tris(2-ethyl-3,3-dimethyl-butyl)aluminum, tris(2-ethyl-3,3-dimethyl-pentyl)aluminum, tris(2-isopropyl-3,3-dimethyl-butyl)aluminum, tris(2-trimethylsilyl-propyl)aluminum, tris(2-methyl-3-phenyl-butyl)aluminum, tris(2-ethyl-3-phenyl-butyl)aluminum, tris(2,3-dimethyl-3-phenyl-butyl)aluminum, tris(2-phenyl-propyl)aluminum, tris[2-(4-fluoro-phenyl)-propyl]aluminum, tris[2-(4-chloro-phenyl)-propyl]aluminum, tris[2-(3-isopropyl-phenyl)-propyl]aluminum, tris(2-phenyl-butyl)aluminum, tris(3-methyl-2-phenyl-butyl)aluminum, tris(2-phenyl-pentyl)aluminum, tris[2-(pentafluorophenyl)-propyl]aluminum, tris[2,2-diphenyl-ethyl]aluminum and tris[2-phenyl-2-methyl-propyl]aluminum, and combinations thereof. Corresponding compounds to those listed above wherein one of the hydrocarbyl groups is replaced with a hydrogen atom, and wherein one or two of the hydrocarbyl groups are replaced with an isobutyl group are also useful in the present subject matter.

Non-limiting examples of preferred aluminum compounds useful in the present subject matter include trimethylaluminum (TMA), triisobutylaluminum (TIBA), tris(2,4,4-trimethyl-pentyl)aluminum (TIOA), tris(2,3-dimethylbutyl)aluminum (TDMBA), tris(2,3,3-trimethylbutyl)aluminium (TTMBA), and combinations thereof.

Non-limiting examples of compounds useful in the present subject matter to form an alkylmetallocene cation are compounds of formula (VII)

D⁺E⁻ (VII)

wherein D⁺ is a Brønsted acid, able to donate a proton and react irreversibly with substituent X of the metallocene compound of formula (I), and E⁻ is a compatible anion, which is able to stabilize the active catalytic species originating from the reaction of D⁺ and the metallocene compound of formula (I), and which is sufficiently labile to be removed by an olefinic monomer. In a preferred aspect of the present subject matter, the anion E⁻ comprises one or more boron atoms. In a more preferred aspect of the present subject matter, the anion E⁻ is an anion of the formula BAr₄⁽⁻⁾, wherein Ar is an aryl radical such as phenyl, pentafluorophenyl, bis(trifluoromethyl)phenyl, and combinations thereof. Tetrakis-pentafluorophenyl borate is a particularly preferred compound, as described in WO 91/02012.

Moreover, compounds of formula (VIII)

BAr₃ (VIII)

can be used in the present subject matter to form compound F of formula (VII). Compounds of this type are described, for example, in the International patent application WO 92/00333. Other examples of compounds able to form an alkylmetallocene cation are compounds of formula (VIII)

BAr₃P (VIII)

wherein P is a substituted or unsubstituted pyrrol radical. These compounds are described in WO01/62764. Compounds containing boron atoms can be conveniently supported according to the description of DE-A-19962814 and DE-A-19962910. Compounds of formula VII-VIII containing at least one boron atom can be used in a molar ratio of about 1:1 and about 10:1, preferably between about 1:1 and about 2.1, and more preferably about 1:1, wherein the ratio between the boron atom and M of the metallocene compound of formula (I) determines the ratio factors.

Additionally, non limiting examples of compounds of formula D⁺E⁻ (VII) useful in the present subject matter include:
Triethylammoniumtetra(phenyl)borate,
Tributylammoniumtetra(phenyl)borate,
Trimethylammoniumtetra(tolyl)borate,
Tributylammoniumtetra(tolyl)borate,
Tributylammoniumtetra(pentafluorophenyl)borate,
Tributylammoniumtetra(pentafluorophenyl)aluminate,
Tripropylammoniumtetra(dimethylphenyl)borate,
Tributylammoniumtetra(trifluoromethylphenyl)borate,
Tributylammoniumtetra(4-fluorophenyl)borate,
N,N-Dimethylbenzylammonium-tetrakispentafluorophenylborate,
N,N-Dimethylhexylamonium-tetrakispentafluorophenylborate,
N,N-Dimethylaniliniumtetra(phenyl)borate,
N,N-Diethylaniliniumtetra(phenyl)borate,
N,N-Dimethylaniliniumtetrakis(pentafluorophenyl)borate,
N,N-Dimethylaniliniumtetrakis(pentafluorophenyl)aluminate,
N,N-Dimethylbenzylammonium-tetrakispentafluorophenylborate,
N,N-Dimethylhexylamonium-tetrakispentafluorophenylborate,
Di(propyl)ammoniumtetrakis(pentafluorophenyl)borate,
Di(cyclohexyl)ammoniumtetrakis(pentafluorophenyl)borate,
Triphenylphosphoniumtetrakis(phenyl)borate,
Triethylphosphoniumtetrakis(phenyl)borate,
Diphenylphosphoniumtetrakis(phenyl)borate,
Tri(methylphenyl)phosphoniumtetrakis(phenyl)borate,
Tri(dimethylphenyl)phosphoniumtetrakis(phenyl)borate,
Triphenylcarbeniumtetrakis(pentafluorophenyl)borate,
Triphenylcarbeniumtetrakis(pentafluorophenyl)aluminate,
Triphenylcarbeniumtetrakis(phenyl)aluminate,
Ferroceniumtetrakis(pentafluorophenyl)borate,
Ferroceniumtetrakis(pentafluorophenyl)aluminate.
Triphenylcarbeniumtetrakis(pentafluorophenyl)borate, and
N,N-Dimethylaniliniumtetrakis(pentafluorophenyl)borate.

Additional examples of compounds of formula D⁺E⁻ (VII) which are useful according to the present subject matter are described in WO 04/005360, WO 02/102811, and WO 01/62764.

Additionally, the catalyst system described herein can also be supported on an inert carrier. This is achieved by depositing the metallocene compound of formula (I), or a product of a reaction of the metallocene compound of formula (I) and the alumoxane, or a product of a reaction of the metallocene compound of formula (I) and the compound able to form an alkylmetallocene cation, on an inert support. Non-limiting examples of inert supports include silica, alumina, Al—Si, Al—Mg mixed oxides, magnesium halides, styrene/divinylbenzene copolymers, polyethylene, polypropylene, and combinations thereof.

Moreover, the catalyst system can be supported on an inert support by depositing the alumoxane, or the compound able to form an alkylmetallocene cation, and the metallocene compound of formula (I) on an inert support. The process to deposit the catalyst system on an inert support is carried out in an inert solvent at a temperature ranging from 0° C. to 100° C. Preferably, the process is carried out at room temperature. Non-limiting examples of inert solvents include hydrocarbons such as toluene, hexane, pentane, propane, and mixtures thereof.

A suitable class of inert supports which can be used include porous organic supports functionalized with groups having active hydrogen atoms. Particularly suitable inert supports include those in which the inert support comprises a partially cross-linked styrene polymer. Inert supports of this type are described in European application EP-633 272.

Another class of inert supports particularly useful for the present subject matter include polyolefin porous prepolymers. In preferred aspect of the present subject matter, polyolefin porous prepolymers comprising polyethylene, polypropylene, and combinations thereof are particularly useful.

Additionally, further useful inert supports according to the present subject matter include porous magnesium halides, such as those described in International application WO 95/32995.

### Melt Blown Resins

The melt blown resins of the present subject matter generally relate to polypropylene melt blown resins. The polypropylene melt blown resins of the present subject matter can comprise a polypropylene homopolymer or polypropylene copolymer, wherein the copolymer is produced from a monomer having the formula (X)

CH₂═CHR¹¹ (X)

wherein R¹¹ is hydrogen or a C₁-C₁₀ hydrocarbon.

In a preferred aspect, the present subject matter relates to various polypropylene homopolymer melt blown resins. In this regard, the present subject matter preferably relates to a polypropylene homopolymer melt blown resin comprising a melt flow rate of about 300 to about 2500 g/10 min. at 230° C., a polydispersion index of about 1.3 to about 2.9, and a melting point of at least 160° C.

Previously known melt blown resins do not have a melt flow rate above about 500 g/10 min. at 230° C., a melting point of at least 160° C., and a polydispersion index of about 1.3 to about 2.9. In particular, previously known melt blown resins do not have all of the above properties in combination.

Additionally, as previously discussed, the previous melt blown resins produce inferior melt blown resin fibers when the resins are processed. This is due to the previous melt blown resins not having a melt flow rate above about 500 g/10 min. at 230° C., a melting point of at least 160° C., and a polydispersion index of about 1.3 to about 2.9.

Accordingly, the present polypropylene melt blown resins are unique in that they have a combination of high melt flow rate, high melting temperature, and lower polydispersion index. In a preferred aspect of the present subject matter, the polypropylene melt blown resins comprise a melt flow rate of about 500 to about 2000 g/10 min. at 230° C. In yet another preferred aspect of the present subject matter, the polypropylene melt blown resins comprise a melt flow rate of about 1200 to about 1800 g/10 min. at 230° C. In yet another aspect of the present subject matter, the polypropylene melt blown resins comprise a melting point of at least 163° C.

In addition to comprising a high melt flow rate and melting point, the melt blown resins of the present subject matter comprise a lower polydispersion index than previously known melt blown resins. This is especially true of previously known melt blown resins produced by Ziegler-Natta catalyst systems. The lower polydispersion index of the resins of the present subject matter, which is a function of the molecular weight distribution of the resins, result in the present melt blown resins having a lower polydispersion index (i.e., narrower molecular weight distribution) compared to previously known melt blown resins. This is especially true or previously known melt blown resins produced from Zeigler-Natta catalyst systems. Additionally, the lower polydispersion index of the resins of the present subject matter have superior processing properties compared to previously known melt blown resins, which have higher polydispersion indexes (i.e., broader molecular weight distributions). In particular, the present melt blown resins produce less spinning smoke when processed, which is a result of having a lower polydispersion index of about 1.3 to about 2.9. In yet another preferred aspect of the present subject matter, the polypropylene melt blown resins comprise a polydispersion index of about 1.4 to about 2.0. In yet another preferred aspect of the present subject matter, the polypropylene melt blown resins comprise a polydispersion index of about 1.4 to about 1.8.

In yet another aspect of the present subject matter, the polypropylene melt blown resins comprise an isotacticity greater than about 90%. In yet another aspect of the present subject matter, the polypropylene melt blown resins comprise an isotacticity greater than about 94%. In yet another aspect of the present subject matter, the polypropylene melt blown resins comprise an isotacticity greater than about 96%.

Additionally, as previously discussed, attempts have been made to increase the melt flow rate of polypropylene melt blown resins by visbreaking. The process of visbreaking polypropylene melt blown resins to increase the melt flow rate is achieved by lowering the molecular weight of the polypropylene polymer chains within the resin through chemical reactions with harsh chemicals, such as radical reactions initiated by peroxides. The melt blown resins, and products produced from these resins, obtained by visbreaking have many drawbacks, including a high yellowing index, a higher propensity for degradation, and an increased amount of by-products within the resins. For this reason, the polypropylene melt flow resins of the present subject matter are not visbroken, and accordingly do not contain residues of peroxide compounds from visbreaking processes.

Additionally, to regulate the mechanical and physical properties of the resins of the present subject matter, stabilizers can be added. Non-limiting examples of preferred stabilizers include antioxidants, such as sterically hindered phenols and sterically hindered amines, UV stabilizers, processing stabilizers, such as phosphites or phosphonites, acid scavengers, such as calcium stearate, zinc stearate, or dihydrotalcite, as well as calcium, zinc, and sodium caprylate salts. In general, the polypropylene melt blown resins of the present subject matter can comprise one or more stabilizers in an amount up to about 5% by weight.

Moreover, lubricants and mold release agents can be added to the present polypropylene melt blown resins. Non-limiting examples of lubricants and mold release agents include fatty acids and salts thereof including, calcium, sodium and zinc, fatty acid amides and salts thereof, or low molecular weight polyolefin waxes. In general, the polypropylene melt blown resins of the present subject matter can contain one of more lubricants or mold release agents in an amount up to about 5% by weight.

Even more so, fillers can be added to the present polypropylene melt blown resins. Non-limiting examples of fillers include talc, calcium carbonate, chalk, and glass fibers. In general, the polypropylene melt blown resins of the present subject matter can contain one or more fillers in an amount up to about 50% by weight. Preferably, the polypropylene melt blown resins of the present subject matter can contain one or more fillers in an amount up to about 25% by weight. In another preferred aspect of the present subject matter, the polypropylene melt blown resins can contain one or more fillers in an amount up to about 10% by weight.

Nucleating agents can also be used in the polypropylene melt blown resins of the present subject matter. Non-limiting examples of useful nucleating agents include inorganic additives, such as silica or kaolin, salts of monocarboxylic or polycarboxylic acids, such as sodium benzoate, aluminum tert-butylbenzoate, and dibenzylidenesorbitol, or the C₁-C₈-alkyl-substituted derivatives of dibenzylidenesorbitol, such as methyldibenzylidenesorbitol, ethyldibenzylidenesorbitol, and dimethyldibenzylidenesorbitol, and salts of diesters of phosphoric acid, such as sodium 2,2′-methylenebis(4,6-di-tert-butylphenyl)phosphate. Preferably, the polypropylene melt blown resins of the present subject matter can contain one or more nucleating agents in an amount up to about 5% by weight.

Such additives are generally commercially available and are described, for example, in Gächter/Müller, Plastics Additives Handbook, 4th Edition, Hansa Publishers, Munich, 1993.

Generally, the present polypropylene melt blown resins of the present subject matter can be produced by contacting a metallocene compound of formula (I)

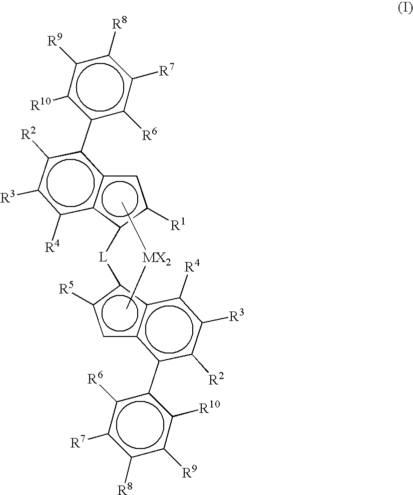

wherein

M is a transition metal of group 3, 4, 5, or 6, or is a lanthanide or actinide in the Periodic Table of Elements;

X is hydrogen, a halogen, or R, OR, OSO₂CF₃, OCOR, SR, NR₂, PR₂, and combinations thereof, or X can form a substituted or unsubstituted butadienyl radical or OR′O;

R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl, or C₇-C₄₀-arylalkyl radical and combinations thereof optionally containing heteroatoms belonging to groups 13-17 of the Periodic Table of Elements;

R′ is a divalent radical selected from C₁-C₄₀ alkylidene, C₆-C₄₀ arylidene, C₇-C₄₀ alkylarylidene, or C₇-C₄₀ arylalkylidene radical;

L is a divalent C₁-C₄₀ hydrocarbon radical optionally containing heteroatoms belonging to groups 13-17 of the Periodic Table of Elements or a divalent silylidene radical containing up to 5 silicon atoms;

R¹ and R⁵ are a C₁-C₄₀ hydrocarbon radical optionally containing heteroatoms belonging to groups 13-17 of the Periodic Table of Elements, wherein R¹ and R⁵ can be the same or different;

R², R³, and R⁴ are hydrogen or C₁-C₄₀ hydrocarbon radicals optionally containing heteroatoms belonging to groups 13-17 of the Periodic Table of Elements, wherein R², R³, and R⁴ can be the same or different;

R⁶, R⁷, R⁸, R⁹, and R¹⁰ are hydrogen or C₁-C₄₀ hydrocarbon radicals optionally containing heteroatoms belonging to groups 13-17 of the Periodic Table of Elements, wherein R⁶, R⁷, R⁸, R⁹ and R¹⁰ can be the same or different with the proviso that at least one of the group consisting of R⁶, R⁷, R⁸, R⁹, and R¹⁰ is not hydrogen, with at least one alumoxane or a compound able to form an alkylmetallocene cation, optionally with an organo aluminum compound, and propylene monomer under reactive conditions.

Additionally, stabilizers, lubricants and mold release agents, fillers, nucleating agents, and other additives can be added to the melt blown resins of the present subject matter by commonly known mixing techniques.

### Melt Blown Resin Fibers

The melt blown resin fibers of the present subject matter generally relate to polypropylene melt blown resin fibers having superior mechanical and physical properties. In this regard, the present subject matter preferably relates to a polypropylene homopolymer melt blown resin fiber comprising a propylene homopolymer melt blown resin comprising a melt flow rate of about 300 to about 2500 g/10 min. at 230° C., a polydispersion index of about 1.3 to about 2.9, and a melting point of at least 160° C.

Previously known melt blown resin fibers produced from previously known melt blown resins are inferior to the present melt blown resin fibers produced from the present melt blown resins for a variety of reasons. As previously discussed, previous melt blown resin fibers were produced from melt blown not having a melt flow rate above about 500 g/10 min. at 230° C., a melting point of at least 160° C., and a polydispersion index of about 1.3 to about 2.9. Accordingly, the fibers produced from these previously known resins would clump and stick together after being extruded from processing. Additionally, fibers produced from previously known melt blown resins have less filament attenuation. Thus, the fibers produced from the previous melt blown resins are not as fine as the fibers produced from the present melt blown resins. Since melt blown resin fibers produced from previously known melt blown resins tend to clump and stick together after being extruded from the processor, the variation and distribution of the fineness of the fibers produced is very large. This in turn can negatively affect products produced from the fibers.

Accordingly, in a preferred aspect of the present subject matter, the melt blown resin fibers have a diameter of about 0.1 to about 10 μm. In another preferred aspect of the present subject matter, the melt blown resin fibers have a diameter of about 1 to about 6 μm.

In addition to the fineness of the fibers produced, the present melt blown resin fibers can comprise unexpected higher static charge retention rates than previously known melt blown resin fibers. In particular, the present melt blown resin fibers can exhibit equal or higher static charge retention rates than fibers produced from currently commercially available melt blown resins. In particular, unformulated melt blown resins of the present subject matter can exhibit equal or higher static charge retention rates than formulated commercially available melt blown resins.

Moreover, as previously discussed, the present melt blown resin fibers produce a lower amount of spinning smoke when processed due to the present melt blown resins comprising lower amounts of volatiles, which is reflected in the present melt blown resin fibers having a lower polydispersion index.

### Non-Woven Fabrics

The non-woven fabrics of the present subject matter generally relate to non-woven fabrics comprising the melt blown resin fibers of the present subject matter. In this regard, the present subject matter preferably relates to a non-woven fabric comprising a polypropylene homopolymer melt blown resin fiber comprising a propylene homopolymer melt blown resin comprising a melt flow rate of about 300 to about 2500 g/10 min. at 230° C., a polydispersion index of about 1.3 to about 2.9, and a melting point of at least 160° C. Additionally, the non-woven fabrics of the present subject matter can comprise a single layer or multiple layer construction. The multiple layer construction can comprise a single or multiple layers of the melt blown resins of the present subject matter.

The non-woven fabrics of the present subject matter exhibit superior mechanical and physical properties, such as filtration and barrier properties, than previously known non-woven fabrics comprising previously known melt blown resins. In particular, the present non-woven fabrics exhibit superior static charge retention rates and filtration efficiencies, which allow the present non-woven fabrics to be used as effectively, or more effectively as a filter or barrier, than previously known non-woven fabrics comprising previously known melt blown resins. This is due to the unique properties of the melt blown resin fibers produced from the present melt blown resins obtained from the present catalyst systems.

### EXAMPLES

The following examples are illustrative of preferred melt blown resins, melt blown resin fibers, and non-woven fabrics comprising the present melt blown fibers, and are not intended to be limitations thereon. All polymer molecular weights are mean average molecular weights. All percentages are based on the percent by weight of the final resin, fiber, non-woven fiber, or product unless otherwise indicated, and all totals equal 100% by weight.

The following examples illustrate preferred aspects of the present subject matter.

### Example I

### Preparation of Polypropylene Resins

The catalyst system is prepared as described in PCT/EP2004/007061 by using rac-dimethylsilylene(2-methyl-4(4′tertbutyl-penhyl)-indenyl)(2-isopropyl-4(4′tertbutyl-penhyl)-indenyl)zirconium dichloride prepared as described in US 2003/0149199 instead of rac-dimethylsilylbis(2-methyl-4,5-benzo-indenyl)-zirconium dichloride.

### Propylene Polymerization

The catalyst system in the form of catalyst mud obtained as described in PCT/EP2004/007061 is fed in the precontact vessel in which it is diluted with about 5 (Kg/h) of propane. From the pre-contact vessel the catalyst system is fed to the prepolymerization loop in which propylene is fed at the same time according to the data reported in table 1. The residence time of the catalyst in the prepolymerization loop is 8 minutes. The prepolymerized catalyst obtained in the prepolymerization loop is then continuously feed into the first loop reactor in which propylene, is fed according to Table 1. The polymer is discharged from the first loop reactor, separated from the unreacted monomer and dried. The reaction conditions are reported in table 1. The MFR of the product is controlled by the feed of hydrogen.

TABLE 1

| | Prepolymerization | C₃ | H₂ | temperature |
|---|---|---|---|---|
| Ex | temperature (° C.) | (Kg/h) | (ppm (mol)) | (° C.) |
| 1 | 45 | 328 | 525 | 70 |
| 2 | 45 | 333 | 738 | 70 |
| 3 | 45 | 339 | 900 | 70 |

### Example II

### Test Methods

Melt Flow Rate (“MFR”) was determined by ASTM D1238, (230° C.; 2.16 kg), units of dg/min.

Molecular Weight Distribution (“Mw/Mn”) was determined by measuring Mw and Mn using gel permeation chromatography (GPC). The measurements were made using a Waters GPCV 2000 Alliance machine with a Waters styragel HMW 6E Toluene, 300 mm length, mixed bed column. The measurement temperature was 150 C. 1,2,4-trichlorobenzene was used as the solvent. A sample concentration of 70 mg/72 g (0.097 wt %) is supplied in an amount of 209.5 μL for the measurement. The values of Mw and Mn are derived using a calibration curve formed using a polystyrene standard.

Fractions soluble and insoluble in xylene at 25° C. was determined by dissolving 2.5 g of polymer in 250 ml of xylene at 135° C. under agitation. After 20 minutes the solution is allowed to cool to 25° C., still under agitation, and then allowed to settle for 30 minutes. The precipitate is filtered with filter paper, the solution evaporated in nitrogen flow, and the residue dried under vacuum at 80° C. until constant weight is reached. Thus one calculates the percent by weight of polymer soluble and insoluble in xylene at ambient temperature.

Polydispersity index (P.I.) was determined by the measurement of molecular weight distribution in the polymer. To determine the PI value, the modulus separation at low modulus value, e.g. 500 Pa, is determined at a temperature of 200° C. by using a RMS-800 parallel plates rheometer model marketed by Rheometrics (USA), operating at an oscillation frequency which increases from 0.01 rad/second to 100 rad/second. From the modulus separation value, the PI can be derived using the following equation:

PI=54.6×(modulus separation)^{-1.76}

wherein the modulus separation (MS) is defined as:

MS=(frequency at G′=500 Pa)/(frequency at G″=500 Pa)

wherein G′ is the storage modulus and G″ is the low modulus.
Density was determined by ASTM D1505.
Melting point was determined by ASTM D2117.
Hydrostatic pressure (i.e., hydrohead) was determined by INDA Standard Test Method IST 80.6.
Air permeability was determined by ASTM D737.

### Test Results

As previously discussed, the present melt blown resins exhibit superior mechanical and physical properties, which in turn produces superior products, such as melt blown resin fibers and non-woven fabrics. Table 2 lists six melt blown resin samples which have been tested. Comparative Examples 1-3 show three different melt blown resins, all produced from catalyst systems different than the catalyst system of the present subject matter. In particular, Comparative Examples 1-3, which are respectively resins HH661, HH662H, and PRO17 distributed by Basell, were produced from previously known Zeigler-Natta catalyst systems. Additionally, Comparative Examples 2 and 3 were visbroken (i.e., chemically peroxide treated).

Examples 1-3 show three melt blown resins of the present subject matter, produced from the catalyst systems of the present subject matter. In particular, Examples 1-3 were produced from the present catalyst systems, and where not visbroken (i.e., chemically peroxide treated). Accordingly, Examples 1-3 exhibit a combination of higher melt flow rate, high melting point, and smaller polydispersion index than Comparative Examples 1-3.

TABLE 2

| | Comparative | Comparative | Comparative | Example | Example | Example |
|---|---|---|---|---|---|---|
| | Example 1 | Example 2 | Example 3 | 1 | 2 | 3 |
| Melt Flow | 440 | 440 | 440 | 500 | 1200 | 1800 |
| Rate (MFR) | | | | | | |
| MFR after vis- | 440 | 1100 | 2000 | n/a | n/a | n/a |
| broken | | | | | | |
| Hexane | 2.84 | 2.84 | 2.84 | 0.60 | 0.47 | 0.86 |
| solubles (%) | | | | | | |
| Xylene | 3.4 | 3.4 | 3.4 | 1.03 | 1.09 | 1.34 |
| solubles (%) | | | | | | |
| Melting Point | | | | 164.4 | 164.5 | 164.2 |
| (° C.) | | | | | | |
| Density | — | — | — | 0.9099 | 0.9096 | 0.9107 |
| Total volatiles | 7053 | 7053 | 7053 | n/a | 690 | 1651 |
| (ppm) | | | | | | |
| Mn | — | 22,000 | — | — | 33,000 | 32,000 |
| Mw | — | 121,000 | — | — | 88,000 | 81,000 |
| Mz | — | 410,000 | — | — | 156,000 | 147,000 |
| Mw/Mn | — | 5.5 | — | — | 2.65 | 2.53 |
| Mz/Mw | — | 3.4 | — | — | 1.77 | 1.82 |
| Polydispersion | 4.0 | 3.3 | 3.2 | 1.7 | 1.6 | 1.5 |
| Index (PI) | | | | | | |
| Tm | 162 | 162 | 162 | 154 | 154 | 154 |
| Tc | — | 121.3 | — | 104 | 104 | 100 |

### Example III

### Process for Producing Melt Blown Fibers and Melt Blown Non-Woven Fabrics

Production of melt blown fibers, and melt blown fabric starts with the melting and extrusion (or co-extrusion using multiple extruders) of the melt blown resin or resins. Extrusion of the resin can be accomplished at elevated temperatures with both single and twin screw extruders (both co and counter rotating) with various L/D ratios and a variety of screw designs in order to optimize the homogeneity of the polymer melt. The continuous delivery of the polymer melt to the die is accomplished through a metering pump which ensures a consistent delivery of polymer melt to the die or spinneret under constant pressure and conditions flow.

In order to promote low polymer viscosity and hence the opportunity for the formation of finer fibers and better barrier properties, the melt blown process can be performed at very high temperatures, significantly higher than the melting point of the resin or resins being extruded. Furthermore, in the melt blowing process hot, pressured air (i.e., hot process or draw air) exiting adjacent (either impinging or parallel to the polymer flow) to the polymer melt is used to further attenuate and draw-down the polymer melt in an attempt to form finer fibers with smaller diameters, typically in the 1-10μ range. The hot process or draw air can be at a temperature at or above the melt temperature of the extruded resin or resins.

A variety of melt blown dies or spinnerets designs can be used for forming melt blown resin fibers from the melt blown resin in a spinning process. The melted melt blown resin can be passed through a specially designed orifice or hole in a die, venture, or spinneret at very high velocities. Most typically apparatuses used to prepare melt blown resin fibers fall under one of two categories, both of which use hot, and typically pressured air, for the melt blowing process. In particular, dies with a single row of holes with air quenching can be used. In this case the die contains a single row of small orifices or die holes across the face of the die, venture, or spinneret. This kind of die, venture, or spinneret design is suitable for all sort of melt blown non-woven fabric production and can be linked to a number of other dies so that, sequentially, the non-woven fabric is produced from several apparatuses, and can form a non-woven fabric or film with a multi-layered structure. The multilayer structure can comprise other melt blown resins, non melt blown resins, non-woven fabrics (such as Spunbond) and/or at least one film or laminate layer. This type of die design with air quench is most suited for very low to low to moderate basis weight fabrics.

In addition to dies with a single row of holes with air quenching, dies with multiple rows of holes with water quench can be used. In the system with water quenching the die contains multiple rows, typically from 5 to 12, of small orifices across the face of the die, venture, or spinneret. This system is characterized by higher throughput capability, lower die temperature requirements, and less polymer degradation. Additionally, it is more suitable for heavier basis weight fabrics.

Upon exit from the die, venture, or spinneret, the resultant hot extrudate is quenched with air or water, as described above, and appears in the form of separate fibers or filaments. They exhibit extremely low diameters and contain a relatively low level of orientation.

The stream of fibers or filaments are then cooled and sprayed on to a moving screen or belt. The non-woven web carries with it a considerable amount of residual heat, so much so that there is a tendency for self-bonding. The combination of self-bonding as well as mechanical entanglement of the filaments create a cohesive and structurally sound fabric that may not require thermal bonding with a calander. However, calanders can be used, wherein the web is passed between heated embossed rollers and is typical in other non-woven processes like spunbond.

Finally, the nonwoven web is collected by being wound-up on a roll.

Specific Equipment which can be Used for Non-Woven Fabrics

Bi-component (Bi-co) melt blowing fabrics are made on a Reifenhäuser REICOFIL 500 mm Melt Blowing Line. The Bi-co line simultaneously employs two 50 mm extruders. The line can produce non-woven fabric from melt blown resins of 10-300 g/sm with polypropylene, polyolefin mixtures, and many related polymers. Maximum throughput is about 50-70 kg/hr. The maximum line speed is about 200 m/min. Effective melt blown fabric width can be about 500 mm.

The REICOFIL Bi-co melt blowing line employs two 50 mm (1/d=25) extruders. Each is capable of individual heat control from extruder to the die body. Each has its own molten polymer metering pump with 20 cc/rev/pump output.

Melt blowing is accomplished through a 600 mm slot die of 601 holes. Each hole is 0.4 mm diameter. The two molten polymer streams are combined before the slot die and pass through a breaker plate with filter screen. Hot air is distributed on each side of the slot die, thus uniformly extending the molten polymer before quenching to a solid fibril.

The fibrils are collected on a moving screened belt, or collector. The vertically adjusting equipment frame can vary the Die-Collector Distance (DCD). The fabric is collected as doff able rolls by a 500 mm tension controlled winder.

### Example IV

### Filtration Efficiency Test Method

The filtration efficiency of a non-woven fabric comprising fibers produced from the polypropylene melt blown resins of the present subject matter was compared to a non-woven fabric comprising fibers produced from a previously known and commercially available melt blown resin. In order to compare the filtration efficiency of each non-woven fabric, two non-woven fabrics were produced by conventional means known in the art from fibers comprising a melt blown resin of the present subject matter, and a non-woven fabric was produced from fibers comprising a commercially available melt blown resin Valtec HH442H distributed by Basell. The filtration efficiency of both fabrics were then compared by subjecting both fabrics to corona charge by passing the fabrics through ionized air. Both fabrics were then measured for filtration efficiency over time at room temperature (RT) and elevated temperatures to accelerate electrostatic charge decay. The apparatus used to determine filtration efficiency was CertiTest® Model 8127/8130 Automated Filter Tester by TSI.

### Test Results

Example 3 is a non-woven fabric produced from fibers comprising the present melt blown resins produced from the present metallocene catalyst system, while Comparative Example 5 is a non-woven fabric produced from fibers of a commercially available melt blown resin produced from a Ziegler-Natta catalyst system. As shown in Table 3A, the non-woven fabric produced from fibers comprising a melt blown resin of the present subject matter exhibited a higher filtration efficiency, and thus retained a higher static charge, than the non-woven fabric produced from fibers comprising the commercially available melt blown resin.

Filtration Efficiency at Different Times after Corona Charging

TABLE 3A

| | 8 hrs. | 36 hrs. | 25 hrs. | 1 week | 1 week | 1 month | 1 month |
|---|---|---|---|---|---|---|---|
| | RT | RT | at 70° C. | at 45° C. | at RT | at 45° C. | at RT |
| Example 3 | 98 | 97 | 89 | 93 | 96 | 92 | 96 |
| Comparative | 96 | 95 | 83 | 87 | 93 | 85 | 91 |
| Example 5 | | | | | | | |

Example 4 is another non-woven fabric produced from fibers comprising the present melt blown resins produced from the present metallocene catalyst system, while Comparative Example 6 is another non-woven fabric produced from fibers of a commercially available melt blown resin produced from a Ziegler-Natta catalyst system. As shown in Table 3B, the non-woven fabric produced from fibers comprising a melt blown resin of the present subject matter exhibited a comparable filtration efficiency and thus retained a comparable static charge, compared to the non-woven fabric produced from fibers comprising the commercially available melt blown resin

Filtration Efficiency at Different Times after Corona Charging (%)

TABLE 3B

| | 8 hrs. | 24 hrs. | 30 hrs. | 45 days | 45 days |
|---|---|---|---|---|---|
| | RT | at 70° C. | at 130° C. | at 45° C. | at RT |
| Example 4 | 94 | 90 | 68 | 94 | 95 |
| Comparative | 98 | 88 | 77 | 94 | 95 |
| Example 6 | | | | | |

### Example V

### Barrier Properties of Non-Woven Fabrics

The barrier properties of nonwoven fabrics are important factors, often the most important of all factors, in determining the performance and value of the said nonwoven fabric. Fabric barrier properties and characteristics are typically measured by two test methods: a) Hydrostatic (Hydrohead) Pressure (INDA Standard Test Method IST 80.6) measures the resistance of the nonwoven fabric to the penetration of water under static pressure. A higher value in hydrostatic pressure implies a finer nonwoven structure (fibers of higher fineness) with less defects and smaller pores; and b) Air Permeability (ASTM D737) measures the rate of air flow through a material under a differential pressure between the two surfaces of the fabric. A lower value in the air permeability quantifies a lower level of air permeating through the fabric and hence higher barrier properties.

### Test Results

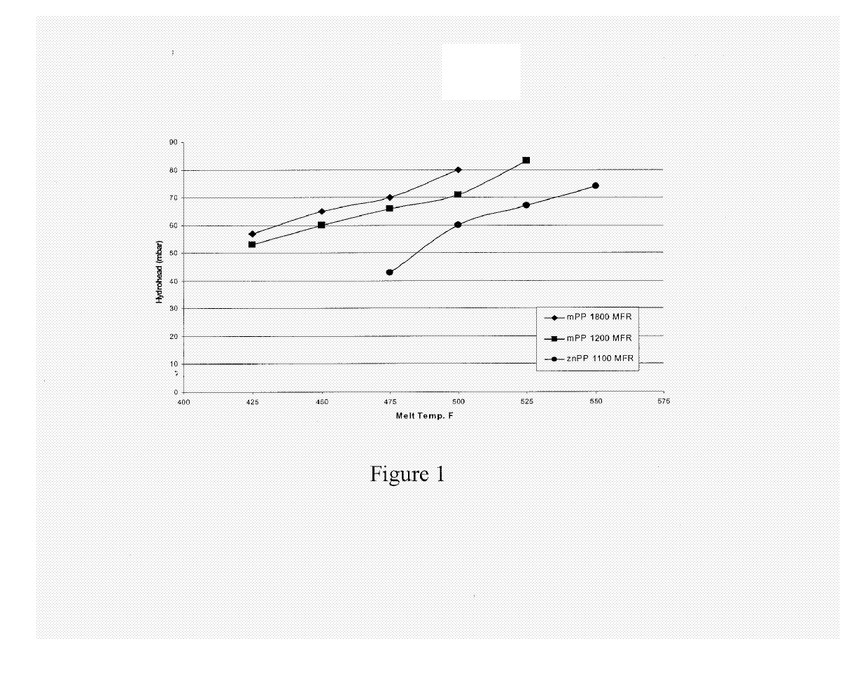

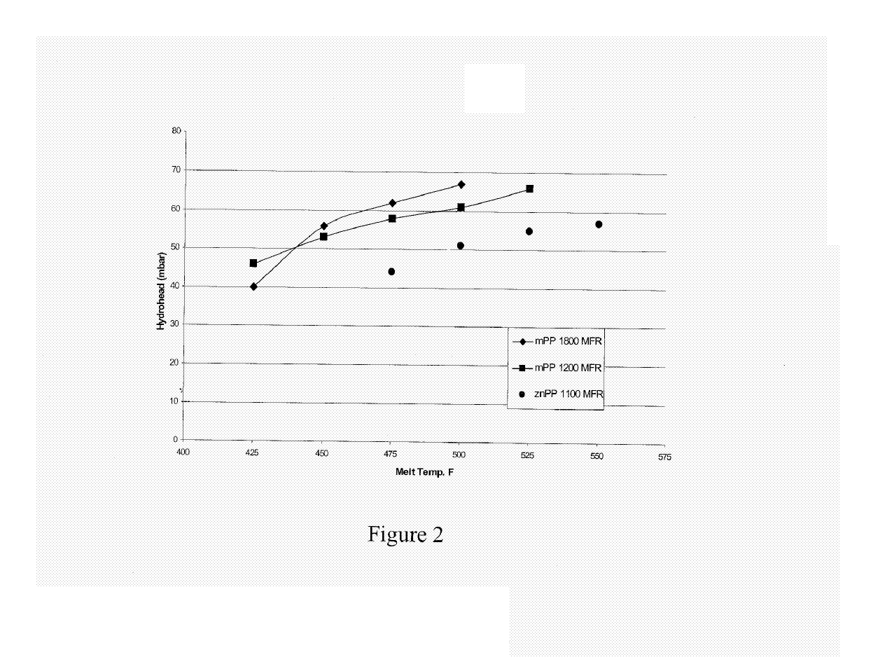

Examples 2 and 3 (mPP 1200 MFR and mPP 1800 MFR) are non-woven fabrics produced from fibers comprising the present melt blown resins produced from the present metallocene catalyst system, while Comparative Example 2 (znPP 1100 MFR) is a non-woven fabric produced from fibers of a commercially available melt blown resin produced from a Ziegler-Natta catalyst system. As shown in FIGS. 1 and 2 (for two different outputs of 0.6 and 0.8 grams/hole/minute) the non-woven fabric produced from fibers comprising a melt blown resin of the present subject matter exhibited a higher hydrostatic pressure (higher hydrohead) than the non-woven fabric produced from fibers comprising the commercially available melt blown resin.

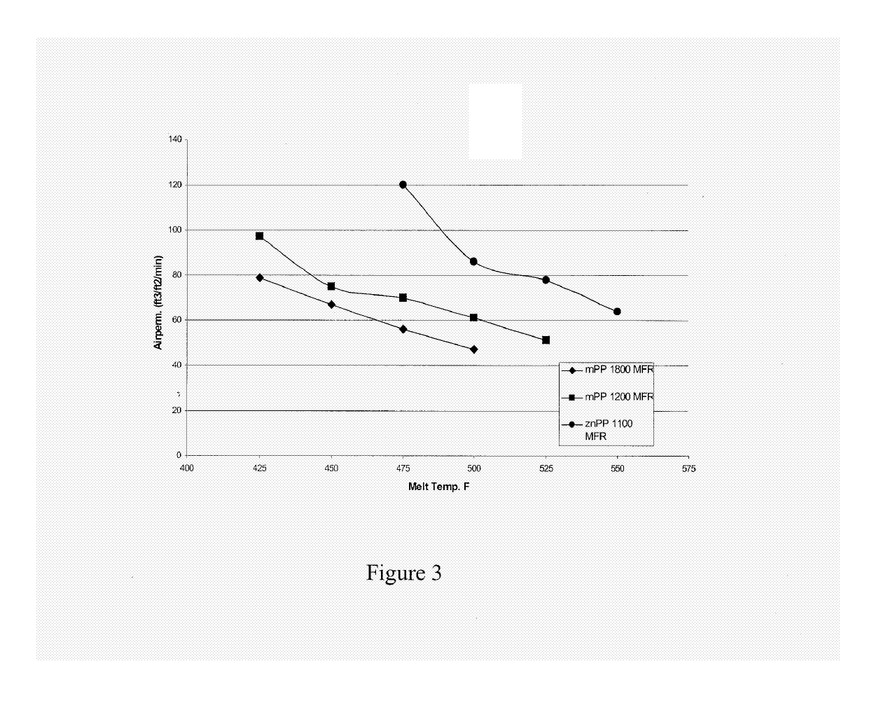

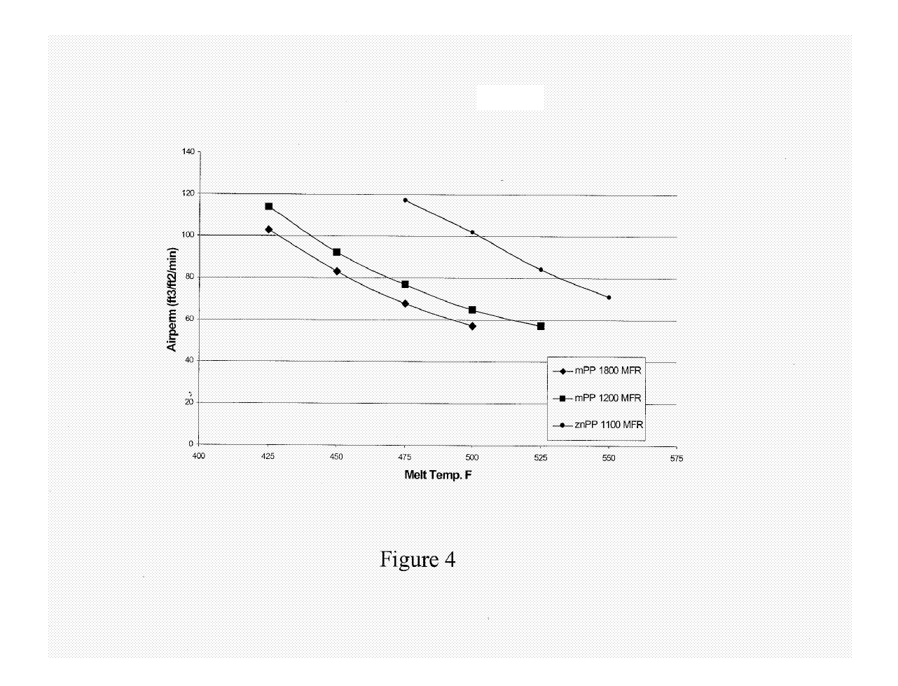

Similarly, Examples 2 and 3 (mPP 1200 MFR and mPP 1800 MFR) are non-woven fabrics produced from fibers comprising the present melt blown resins produced from the present metallocene catalyst system, while Comparative Example 2 (znPP 1100 MFR) is a non-woven fabric produced from fibers of a commercially available melt blown resin produced from a Ziegler-Natta catalyst system. As shown in FIGS. 3 and 4 (for two different outputs of 0.6 and 0.8 grams/hole/minute) the non-woven fabric produced from fibers comprising a melt blown resin of the present subject matter exhibited a lower air permeability than the non-woven fabric produced from fibers comprising the commercially available melt blown resin.

### Example VI

### Processability Efficiency and Energy Conservation

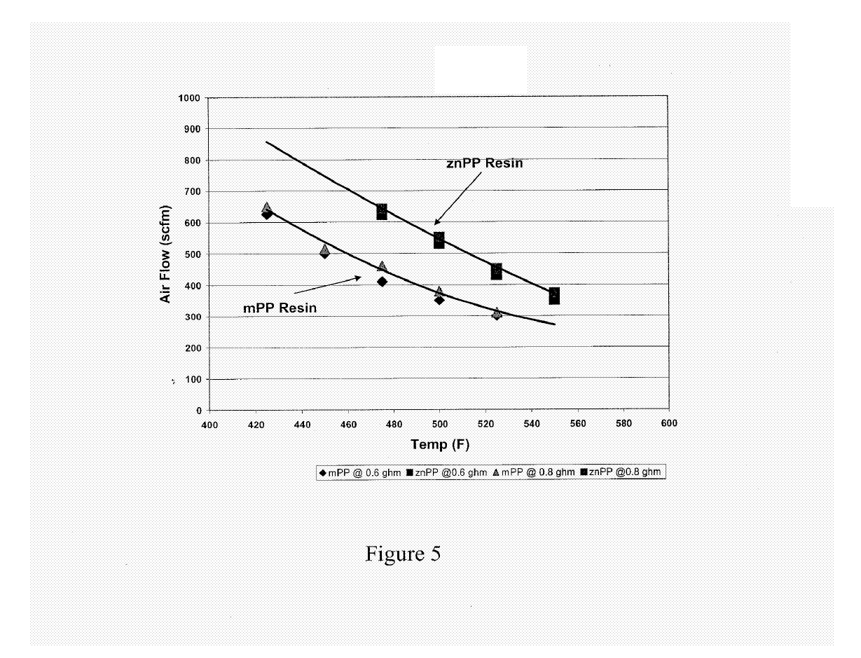

Examples 2 (mPP 1200 MFR) is a non-woven fabric produced from fibers comprising the present melt blown resins produced from the present metallocene catalyst system, while Comparative Example 2 (znPP 1100 MFR) is a non-woven fabric produced from fibers of a commercially available melt blown resin produced from a Ziegler-Natta catalyst system. As shown in FIG. 5 the non-woven fabric produced from fibers comprising a melt blown resin of the present subject matter exhibited formation at reduced temperatures and reduced process air to achieve the improved barrier properties at two extruder outputs (as indicated in Example III) as compared to the non-woven fabric produced from fibers comprising the commercially available melt blown resin.

The present subject matter being thus described, it will be apparent that the same may be modified or varied in many ways. Such modifications and variations are not to be regarded as a departure from the spirit and scope of the present subject matter, and all such modifications and variations are intended to be included within the scope of the following claims.

1. A polypropylene homopolymer melt blown resin comprising a melt flow rate of about 300 to about 2500 g/10 min. at 230° C., a polydispersion index of about 1.3 to about 2.9, and a melting point of at least 160° C.

2. The polypropylene homopolymer melt blown resin of claim 1, wherein said melt flow rate is about 500 to about 2000 g/10 min. at 230° C.

3. The polypropylene homopolymer melt blown resin of claim 1, wherein said melt flow rate is about 1200 to about 1800 g/10 min at 230° C.

4. The polypropylene homopolymer melt blown resin of claim 1, wherein said polydispersion index is about 1.4 to about 2.0.

5. The polypropylene homopolymer melt blown resin of claim 1, wherein said melting point is at least 163° C.

6. The polypropylene homopolymer melt blown resin of claim 1, wherein said polypropylene homopolymer melt blown resin comprises an isotacticity greater than about 90%.

7. The propylene homopolymer melt blown resin of claim 1, wherein said polypropylene homopolymer melt blown resin comprises an isotacticity greater than about 94%.

8. The propylene homopolymer melt blown resin of claim 1, wherein said polypropylene homopolymer melt blown resin comprises an isotacticity greater than about 96%.

9. A process for preparing a polypropylene homopolymer melt blown resin comprising contacting:
a metallocene compound of formula (I) 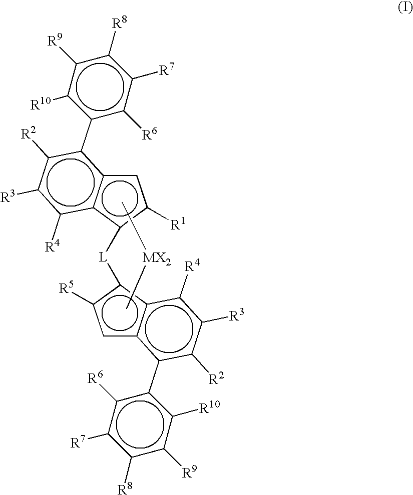
wherein
M is a transition metal of group 3, 4, 5, or 6, or is a lanthanide or actinide in the Periodic Table of Elements;
X is hydrogen, a halogen, or R, OR, OSO₂CF₃, OCOR, SR, NR₂, PR₂, and combinations thereof, or X can form a substituted or unsubstituted butadienyl radical or OR′O;
R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl, or C₇-C₄₀-arylalkyl radical and combinations thereof optionally containing heteroatoms belonging to groups 13-17 of the Periodic Table of Elements;
R′ is a divalent radical selected from C₁-C₄₀ alkylidene, C₆-C₄₀ arylidene, C₇-C₄₀ alkylarylidene, or C₇-C₄₀ arylalkylidene radical;
L is a divalent C₁-C₄₀ hydrocarbon radical optionally containing heteroatoms belonging to groups 13-17 of the Periodic Table of Elements or a divalent silylidene radical containing up to 5 silicon atoms;
R¹ and R⁵ are a C₁-C₄₀ hydrocarbon radical optionally containing heteroatoms belonging to groups 13-17 of the Periodic Table of Elements, wherein R¹ and R⁵ can be the same or different;
R², R³, and R⁴ are hydrogen or C₁-C₄₀ hydrocarbon radicals optionally containing heteroatoms belonging to groups 13-17 of the Periodic Table of Elements, wherein R², R³, and R⁴ can be the same or different;
R⁶, R⁷, R⁸, R⁹, and R¹⁰ are hydrogen or C₁-C₄₀ hydrocarbon radicals optionally containing heteroatoms belonging to groups 13-17 of the Periodic Table of Elements, wherein R⁶, R⁷, R⁸, R⁹ and R¹⁰ can be the same or different with the proviso that at least one of the group consisting of R⁶, R⁷, R⁸, R⁹, and R¹⁰ is not hydrogen;
at least one alumoxane or a compound able to form an alkylmetallocene cation;
optionally an organo aluminium compound; and
propylene monomer,
wherein said propylene monomer is polymerized to form the polypropylene homopolymer melt blown resin comprising a melt flow rate of about 300 to about 2500 g/10 min. at 230° C., a polydispersion index of about 1.3 to about 2.9, and a melting point of at least 160° C.

10-27. (canceled)

28. A polypropylene homopolymer melt blown resin fiber comprising a propylene homopolymer melt blown resin comprising a melt flow rate of about 300 to about 2500 g/10 min. at 230° C., a polydispersion index of about 1.3 to about 2.9, and a melting point of at least 160° C.

29-35. (canceled)

36. The polypropylene homopolymer melt blown resin fiber of claim 28, wherein said fiber has a diameter of about 0.1 to 10 μm.

37. The polypropylene homopolymer melt blown resin fiber of claim 28, wherein said fiber has a diameter of about 1 to 6 μm.

38. A process for preparing a polypropylene homopolymer melt blown resin fiber comprising contacting:
a metallocene compound of formula (I) 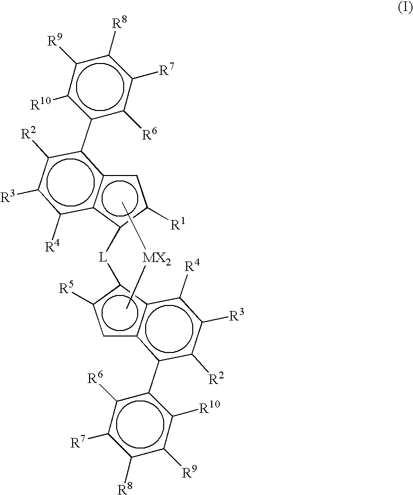
wherein
M is a transition metal of group 3, 4, 5, or 6, or is a lanthanide or actinide in the Periodic Table of Elements;
X is hydrogen, a halogen, or R, OR, OSO₂CF₃, OCOR, SR, NR₂, PR₂, and combinations thereof, or X can form a substituted or unsubstituted butadienyl radical or OR′O;
R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl, or C₇-C₄₀-arylalkyl radical and combinations thereof optionally containing heteroatoms belonging to groups 13-17 of the Periodic Table of Elements;
R′ is a divalent radical selected from C₁-C₄₀ alkylidene, C₆-C₄₀ arylidene, C₇-C₄₀ alkylarylidene, or C₇-C₄₀ arylalkylidene radical;
L is a divalent C₁-C₄₀ hydrocarbon radical optionally containing heteroatoms belonging to groups 13-17 of the Periodic Table of Elements or a divalent silylidene radical containing up to 5 silicon atoms;
R¹ and R⁵ are a C₁-C₄₀ hydrocarbon radical optionally containing heteroatoms belonging to groups 13-17 of the Periodic Table of Elements, wherein R¹ and R⁵ can be the same or different;
R², R³, and R⁴ are hydrogen or C₁-C₄₀ hydrocarbon radicals optionally containing heteroatoms belonging to groups 13-17 of the Periodic Table of Elements, wherein R², R³, and R⁴ can be the same or different;
R⁶, R⁷, R⁸, R⁹, and R¹⁰ are hydrogen or C₁-C₄₀ hydrocarbon radicals optionally containing heteroatoms belonging to groups 13-17 of the Periodic Table of Elements, wherein R⁶, R⁷, R⁸, R⁹ and R¹⁰ can be the same or different with the proviso that at least one of the group consisting of R⁶, R⁷, R⁸, R⁹, and R¹⁰ is not hydrogen;
at least one alumoxane or a compound able to form an alkylmetallocene cation;
optionally an organo aluminium compound; and
propylene monomer,
wherein said propylene monomer is polymerized to form a polypropylene homopolymer melt blown resin comprising a melt flow rate of about 300 to about 2500 g/10 min. at 230° C., a polydispersion index of about 1.3 to about 2.9, and a melting point of at least 160° C.; said polypropylene homopolymer melt blown resin is processed in an extruder to form said polypropylene homopolymer melt blown resin fiber.

39-65. (canceled)

66. A non-woven fabric comprising a polypropylene homopolymer melt blown resin fiber comprising a propylene homopolymer melt blown resin comprising a melt flow rate of about 300 to about 2500 g/10 min. at 230° C., a polydispersion index of about 1.3 to about 2.9, and a melting point of at least 160° C.

67-75. (canceled)

76. A multi-layered non-woven fabric comprising a polypropylene homopolymer melt blown resin fiber comprising a propylene homopolymer melt blown resin comprising a melt flow rate of about 300 to about 2500 g/10 min. at 230° C., a polydispersion index of about 1.3 to about 2.9, and a melting point of at least 160° C.

77-90. (canceled)
